(19) United States
(12) Patent Application Publication
(10) Pub. No.: US 2002/0115812 A1
(43) Pub. Date: Aug. 22, 2002

(54) FLAME PROOFING AGENTS FOR POLYURETHANES, A METHOD FOR THE PRODUCTION OF FLAME PROOF POLYURETHANE PLASTICS AND THEIR USE IN RAIL VEHICLE CONSTRUCTION

(76) Inventors: GEZA AVAR, LEVERKUSEN (DE); THOMAS MUNZMAY, DORMAGEN (DE); ANDREAS RUCKES, LANGENFELD (DE); INGO ZAPPEL, LEVERKUSEN (DE)

Correspondence Address: PATENT DEPARTMENT, BAYER CORPORATION, 100 BAYER ROAD, PITTSBURGH, PA, 152059741

(21) Appl. No.: 09/308,469

(22) PCT Filed: Nov. 17, 1997
(86) PCT No.: PCT/EP97/06393

(30) Foreign Application Priority Data
Nov. 28, 1996 (DE) 196 49 279.3

(51) Int. Cl. C08G 18/00

(52) U.S. Cl. 528/44; 252/601; 252/604; 252/609; 521/106; 521/128; 521/163; 521/170; 521/903; 521/906

(57) ABSTRACT

A flame retardant composition that is composed of red phosphorus and melamine or a derivative thereof in amounts satisfying a specified ratio for use in the production of polyurethanes. The polyurethanes produced with this flame retardant composition are particularly useful in the production of rail vehicles.

The invention relates to a flame retardant to improve the fire properties of polyurethane plastics, to polyurethane plastics which are rendered flame-retardant and to the use thereof in rail vehicle construction.

It has not hitherto been possible to use rigid structural foams based on polyurethanes for rail vehicle construction because they do not comply with the requirements of DIN 5510.

DIN 5510 is a regulatory standard which provides comprehensive regulation of preventive (passive) fire protection in rail vehicles. For this purpose, vehicles are classified into fire risk ratings of from 1 to 4 as a function of the degree of hazard they represent. Classification is based first and foremost on the potential for passengers to escape in the event of fire. For example, the restricted escape potential between stations which results when vehicles travel predominantly below ground (in tunnels and underground systems) means that according to this standard such vehicles must be accorded a higher fire risk rating than those which operate above ground.

Fire properties and/or flame resistance behaviour of materials and manufactured components are furthermore laid down in respect of rail vehicle construction. The flame resistance requirements here are based on

i) the fire risk rating of the vehicle,

ii) the size of the component and

iii) the function and installed location of the component in the vehicle.

It would be advantageous technologically and economically to use rigid PUR structural foams in rail transport if they were to comply with the requirements of DIN 5510 (see above). However, this cannot be achieved using the known halogen-free flame retardants (for example ammonium polyphosphate, etc.).

The use of melamine as a flame retardant is known from, for example, EP-A-0 422 797, EP-A-0 428 258, EP-A-0 347 497, EP-A-0 450 403, EP-A-0 377 891, JP-A-7 292 055, U.S. Pat. Nos. 3,681,273 and 3,897,372. However, it is not possible to comply with the requirements of DIN 5510 solely by using melamine, as investigations have shown.

The use of red phosphorus as a flame retardant is likewise known, for example from “Brandverhalten von Kunststoffen”, Dr. Troitzsch, Carl-Hanser-Verlag Munich 1981, p. 64, “Kunststoffe” 79th year 1989/11, Carl-Hanser-Verlag Munich, “Halogenfreier Flammschutz mit Phosphorverbindungen, H. Staendeke, Hürth and D. J. Scharf, Coventry/USA. But the use of red phosphorus cannot alone meet the requirements of DIN 5510, as has been investigated.

Nor is it possible to comply with the requirements of DIN 5510 solely by using other flame retardants such as are described, for example, in “Kunststoffe Brandprüfungen Flammschutzmittel Umweltfragen, Bestandsaufnahme und Perspektiven”, Dr. Troitzsch, p. 21, “Kunststoffe” 79th year 1989/11, Carl-Hanser-Verlag Munich, “Halogenfreier Flammschutz mit Phosphorverbindungen”, H. Staendeke, Hürth and D. J. Scharf, Coventry/USA.

Nor do the known combinations of melamine with phosphoric acid derivatives—as described in EP-A-0 377 891—herald success.

The object of the invention is to provide flame retardants for polyurethanes and polyurethane plastics which are rendered flame-retardant which are suitable in terms of their fire properties for use in rail vehicle construction.

As has now surprisingly been found, the addition of a flame retardant comprising a mixture of red phosphorus and melamine and/or melamine derivatives in a ratio by weight of from 1:7.5 to 1:100 enables polyurethane plastics which are rendered flame-retardant to be obtained which are suitable for use in rail vehicles owing to their fire properties. Polyurethane plastics which are rendered flame-retardant according to the invention comply with the requirements of DIN 5510. It is surprising that this is achieved precisely by this ratio by weight of red phosphorus and melamine and/or melamine derivative, especially as other quantitative ratios have proved unusable.

The present invention therefore provides a flame retardant which is suitable for polyurethane plastics and consists of red phosphorus and melamine and/or melamine derivative in a ratio by weight of from 1:7.5 to 1:100, relative to the red phosphorus.

The ratio by weight is preferably from 1:10 to 1:40.

Melamine and/or melamine derivatives such as, for example, melamine cyanurate, melamine phosphate, melamine borate, melamine oxalate, melamine formate, melamine pyrophosphate, dimelamine phosphate, and the like can be used.

The present invention also provides a process for the production of polyurethane plastics which are rendered flame-retardant, in which

A) organic polyisocyanates

are reacted with

B) compounds having at least two hydrogen atoms which are capable of reacting with isocyanates and a molecular weight of 250 to 12,500,

B1) optionally cross-linking agents having at least two hydrogen atoms which are capable of reacting with isocyanates and a molecular weight of 32 to 249,

B2) optionally fillers, blowing agents, stabilisers, activators and/or further auxiliary substances and additives which are known per se, in the presence of

C) a mixture of red phosphorus and melamine and/or melamine derivative having a ratio by weight of red phosphorus to melamine and/or melamine derivative of from 1:7.5 to 1:100.

The mixture C) is preferably used in a ratio by weight of from 10:90 to 50:50, preferably 15:85 to 30:70, relative to the other components A) and B) or A) and B1) and/or B2).

The following compounds may be used as organic polyisocyanates A): polyisocyanates such as are described, for example, by W. Siefken in Justus Liebigs Annalen der Chemie, 562, pp. 75 to 136, for example those of the formula

Q(NCO)ₙ

in which

n denotes 2 to 4, preferably 2 to 3, and

Q denotes an aliphatic hydrocarbon radical having 2 to 18, preferably 6 to 10, carbon atoms, a cycloaliphatic hydrocarbon radical having 4 to 15, preferably 5 to 10, carbon atoms, an aromatic hydrocarbon radical having 6 to 15, preferably 6 to 13, carbon atoms or an araliphatic hydrocarbon radical having 8 to 15, preferably 8 to 13, carbon atoms, for example polyisocyanates such as are described in DE-OS 28 32 253, pp. 10 to 11.

Polyisocyanates are generally used which are readily accessible industrially, for example 2,4- and 2,6-tolylene diisocyanate and any mixtures of the latter isomers (“TDIs”), polyphenyl polymethylene polyisocyanates, such as are prepared by aniline-formaldehyde condensation followed by phosgenation (“raw MDI”) and polyisocyanates having carbodiimide, urethane, allophanate, isocyanurate, urea or biuret groups (“modified polyisocyanates”), for example modified polyisocyanates derived from 2,4-tolylene diisocyanate and 2,6-tolylene diisocyanate or from 4,4′-diphenylmethane diisocyanate and/or 2,4′-diphenylmethane diisocyanate. Diisocyanato diphenylmethane (MDI) is preferably used either as a pure MDI monomer or mixed with its higher-ring homologues as an MDI polymer.

Compounds having at least two hydrogen atoms which are capable of reacting with isocyanates and a molecular weight of generally 250 to 12,500 g/mole are used as the starting component B). These are understood to include preferably, in addition to compounds having amino, thiol or carboxyl groups, compounds having hydroxyl groups, preferably polyethers, polyesters, polycarbonates, polylactones and polyamides, in particular compounds having from 2 to 8 hydroxyl groups, specifically those such as have a molecular weight of 250 to 10,000, for example such compounds having at least 2, generally from 2 to 8, preferably from 2 to 4, hydroxyl groups, such as are known per se for producing homogeneous and cellular polyurethanes and such as are described, for example, in DE-OS 28 32 253, pp. 11 to 18. Mixtures of different such compounds are also contemplated according to the invention.

The cross-linking components which are optionally used are likewise compounds having at least two hydrogen atoms which are capable of reacting with isocyanates and a molecular weight of 32 to 249. In this case also these are understood to mean compounds having hydroxyl and/or amino and/or thiol and/or carboxyl groups, preferably compounds having hydroxyl and/or amino groups, which serve as cross-linking agents. The latter compounds generally have from 2 to 8, preferably 2 to 4, hydrogen atoms which are capable of reacting with isocyanates. Examples of the latter are described in DE-OS 28 32 253, pp. 19 to 20.

Fillers, blowing agents, stabilisers, activators and further auxiliary substances and additives known per se such as emulsifying agents, reaction retardants, cell regulators, plasticisers, dyes and fungistats and bacteriostats are optionally co-used as component B2). Details of the use and effects of these additives are given in the Kunststoff-Handbuch, Vol. VII, edited by Vieweg and Hochtlen, Carl-Hanser-Verlag, Munich 1966, for example on pages 103 to 113.

Blowing agents which are optionally to be co-used are the blowing agents conventionally used for foaming polyurethane rigid foams.

Examples of such blowing agents are alkanes such as n-pentane, isopentane, mixtures of isopentane and n-pentane, cyclopentane, cyclohexane, blends prepared from butane isomers and the named alkanes, partially halogenated chlorofluorocarbons such as 1,1,1-dichlorofluoroethane (R 141b), partially fluorinated hydrocarbons such as 1,1,1,3,3,3-hexafluorobutane (R 356) or 1,1,1,3,3-pentafluoropropane (R 245 fa).

The polyurethane plastics which are rendered flame-retardant according to the invention may be produced as elastomers by casting, as rigid or flexible foams in a continuous or batch process or as foamed or solid moulded articles.

If cellular moulded parts are to be produced, foaming is normally carried out in closed moulds. In this case the reaction mixture is introduced into a mould. The material considered for the mould is metal, for example aluminium, or plastics material, for example epoxy resin. The foamable reaction mixture foams in the mould and forms the moulded part. Foam moulding may in this case be carried out such that the moulding has a cellular structure at its surface. It may, however, also be carried out such that the moulding has a compact skin and a cellular core. In this context the procedure may be to introduce into the mould sufficient foamable reaction mixture that the foam which forms just fills the mould. It is also, however, possible to introduce into the mould more foamable reaction mixture than is necessary to fill the interior of the mould with foam. This is consequently working by “overcharging”; such a method is disclosed by, for example, U.S. Pat. Nos. 3,178,490 and 3,182,104.

Foams according to the invention may naturally also be produced by slabstock foaming or by the continuous laminating process which is known per se.

The RIM (reaction injection moulding) process is preferably used to produce foams according to the invention as structural foams.

The polyurethane plastics according to the invention show surprisingly good fire properties and are therefore suitable for use in rail vehicle construction. Their fire properties comply with the requirements of DIN 5510.

The present invention therefore also provides the use of the polyurethane plastics described hereinabove in rail vehicle construction.

The Examples which follow are intended to explain the invention without, however, restricting it in scope.

### EXAMPLES

### Embodiment Examples 1 to 3

| Formulation: | |
|---|---|
| Baydur 6110 B | 100 parts by weight |
| Red phosphorus/melamine | 60 to 80 parts by weight |
| Desmodur 44 V 10 | 135 parts by weight |

The specimen slabs were produced to a gross density of 700 kg/m³ and a thickness of 10 mm on a RIMDOMAT electronically controlled high-pressure piston dispensing unit, from Hennecke (St. Agustin, Germany).

### Embodiment Examples 4 to 6

| Formulation: | |
|---|---|
| Baydur VP PU 1598 | 100 parts by weight |
| Red phosphorus/melamine | 60 to 80 parts by weight |
| Desmodur 44 V 10 | 113 parts by weight |

Specimen slabs for embodiment Examples 4 to 6 were made to a gross density of 1200 kg/m³ and a thickness of 4 mm. They were likewise made on a Rimdomat.

The red phosphorus was used in the form of a 50% paste (carrier: castor oil, Hostaflam AP 750 manufactured by Hoechst), and the melamine was used as a powder of particle size average 99% 175-200 μm (manufactured by DSM) for the tests on embodiment Examples 1 to 6.

Testing of Fire Properties

The fire properties of materials and manufactured components are tested to DIN 54 837. The flammability rating (S), the smoke production rating (SR) and the dripping tendency rating (ST) were determined in a flame impingement test. Classification into flammability ratings takes account of both the extent of destruction during flame impingement and the burning duration after flame impingement has ceased.

TABLE 1
Classification criteria for flammability ratings (S) to DIN 5510

| Flammability rating | Length of destroyed portion | Burning duration |
|---|---|---|
| S2 not achieved | >30 cm | open-ended |
| S2 | ≦30 cm | open-ended |
| S3 | ≦25 cm | ≦100 sec |
| S4 | ≦20 cm | ≦10 sec |
| S5 | 0 cm | 0 sec |

The integral reduction in light intensity is measured throughout the test in order to determine the smoke production rating.

TABLE 2
Classification criteria for smoke production rating (SR) to DIN 5510

| Smoke production rating | Integral reduction in light intensity |
|---|---|
| SR 1 | ≦100%* min |
| SR 2 | ≦50%* min |

The dripping tendency ratings are evaluated on the following criteria: does not drip, drips, drops while burning. The dropping behaviour of polyurethanes is influenced less by flame retardants, being a property of the material which is determined by the chemical structure. The Baydur products investigated here are so strongly cross-linked that the drip test is generally passed without difficulty.

TABLE 3
Rating criteria for dripping tendency ratings (ST) to DIN 5510

| Dripping | |
|---|---|
| tendency rating | Observation |
| ST 1 | drops while burning |
| ST 2 | drops while burning, or does not drop while burning* |

*maximum burning duration 20 sec.

For a broad field of application with PUR structural foam materials, ratings of S 4, SR 2 and ST 2 must be achieved.

Brief Description of the Process of DIN 54 837

A test specimen which is arranged vertically is exposed in a combustion box or an appropriately modified combustion chamber to the flame of a gas burner with a wide slit top attachment. The lengths of the test specimen portions destroyed by burning, the smoke production and the dripping behaviour are meanwhile determined.

5 test specimens measuring 500 mm×190 mm×d are used.

Table relating to embodiment Examples 1 to 6

| | | | | | | Length of | | Smoke | Integral of | |
|---|---|---|---|---|---|---|---|---|---|---|
| | | | | | Inflam- | destroyed | Burning | production | smoke | Dripping |
| Test | Flame | Conc. | Flame | Conc. | mability | portion | duration | rating | density | tendency |
| No. | retardant 1 | wt. % | retardant 2 | wt. % | rating S | cm | sec. | SR | % × min. | ST |
| 1 | Melamine | 20 | — | — | S 2 | 22.6 | >120 | SR 1 | 66.8 | ST 2 |
| 2 | Red | 25 | — | — | S 2 | 26.4 | 28.4 | SR 1 not | 198 | ST 2 |
| | phosphorus | | | | | | | achieved | | |
| 3 | Red | 2 | Melamine | 20 | S 4 | 15.8 | 1.6 | SR 2 | 30 | ST 2 |
| | phosphorus | | | | | | | | | |
| 4 | Melamine | 20 | | | S 3 | 19.4 | 46 | SR 1 | 61 | ST 1 |
| 5 | Red | 2 | Melamine | 20 | S 4 | 14.2 | 4.6 | SR 2 | 40 | ST 2 |
| | phosphorus | | | | | | | | | |
| 6 | Red | 8 | Melamine | 20 | S 3 | 19.6 | 50 | SR 1 | 79 | ST 2 |
| | phosphorus | | | | | | | | | |

1. A flame retardant for polyurethane plastics, comprising red phosphorus and melamine and/or melamine derivatives in a ratio by weight of from 1:7.5 to 1:100.

2. A flame retardant according to claim 1, characterised in that the ratio by weight of red phosphorus to melamine and/or melamine derivative is from 1:10to 1:40.

3. A flame retardant according to any one of the previous claims, characterised in that melamine borate, melamine oxalate, melamine formate, melamine pyrophosphate and/or dimelamine phosphate is/are used as a melamine derivative.

4. A flame retardant according to any one of the previous claims, characterised in that red phosphorus is used in the form of a paste or a powder, and melamine is used as a powder having a particle size within the range 150 to 350 μm.

5. A process for the production of polyurethane plastics which are rendered flame-retardant, in which
A) organic polyisocyanates
are reacted with
B) compounds having at least two hydrogen atoms which are capable of reacting with isocyanates and a molecular weight of 250 to 12,500,
B1) optionally cross-linking agents having at least two hydrogen atoms which are capable of reacting with isocyanates and a molecular weight of 32 to 249,
B2) optionally fillers, blowing agents, stabilisers, activators and/or further auxiliary substances and additives which are known per se, in the presence of
C) a mixture of red phosphorus and melamine and/or melamine derivative having a ratio by weight of red phosphorus to melamine and/or melamine derivative of from 1:7.5 to 1:100.

6. A process according to claim 5, characterised in that the mixture C) is used in a ratio by weight, relative to the sum of the other components, of from 10:90 to 50:50.

7. A process according to any one of claims 5 to 6, characterised in that MDI diisocyanate polymer is used as a polyisocyanate.

8. A process according to any one of claims 5 to 7, characterised in that polyurethane structural foams are produced.

9. A polyurethane plastics produced according to any one of claims 5 to 8, characterised in that the polyurethane plastics comply with the fire risk requirements in accordance with DIN 5510.

10. Use in rail vehicle construction of the polyurethane plastics produced according to any one of claims 5 to 8.
